(19) United States
(12) Patent Application Publication
(10) Pub. No.: US 2010/0266132 A1
(43) Pub. Date: Oct. 21, 2010

(54) SERVICE-BASED KEY ESCROW AND SECURITY FOR DEVICE DATA

(75) Inventors: Girish Bablani, Issaquah, WA (US); Anatoliy Panasyuk, Bellevue, WA (US); Scott Colin Cottrille, Sammamish, WA (US); Dennis Batchelder, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/424,151

(22) Filed: Apr. 15, 2009

(51) Int. Cl. H04L 9/08

(52) U.S. Cl. 380/286

(57) ABSTRACT

Data protection services for portable, handheld, or mobile device are provided in part by one or more cooperating network or data service(s), such as a cloud service, that provide volatile encryption/decryption key information to the device(s). Decryption key(s) are retrieved on demand by a device or application of the device from a network service or other data service based on an analysis of device and user credential(s). Retrieval of keys can be triggered automatically by meeting a set of pre-conditions by the device or application, or explicitly or implicitly requested by input to the device or application. Thus, decryption keys are provided to the mobile device in real time, on-demand, explicitly or implicitly defining a volatile lifetime prior to expiration of the decryption keys.

### TECHNICAL FIELD

The subject disclosure relates to data protection services for device(s) based on volatile encryption and/or decryption key information.

### BACKGROUND

By way of background concerning some conventional systems, desktop personal computing devices (PCs) have traditionally executed applications and data services locally to the device. In such case, as data is accessed, processed, stored, cached, etc., the data may travel on the device over local buses, interfaces and other data pathways, however, the user of the desktop has not had to worry about interference or exposure of user data unless somehow the desktop is lost or stolen, which usually involves defeating real world locks and/or real world cameras, or other physical security measures.

However, due to the very portability of portable devices, the risk of such devices becoming lost or stolen increases dramatically. Moreover, the number of computing devices including mobile devices, such as smart phones, media players, laptops, netbooks, and other mobile devices has been exploding relative to desktop computers. For instance, in some cases, users, such as business professionals, travelers, etc., carry multiple portable computing devices, e.g., a laptop, a smart phone and another mobile device, such as an MP3 and/or or video player. Some conventional mobile devices include laptops, mobile phones and other smart devices, blackberry multimedia devices, and other devices, and a fair amount of diversity exists among different operating systems supported by such devices. Typically, such devices provide instant access to corporate e-mail, contacts, calendar, documents and other important information, basically enabling people on the move to have “information at their fingertips”, wherever there is access to one or more supporting networks, applications and services.

However, one of the side-effects of this shift to more mobile devices is a significant increase in security risk to device data, as highly sensitive information is routinely stored on multiple mobile devices that can be lost, stolen or misplaced, whereas the stationary, “behind locked door and key” nature of desktop computers has required more of a traditional security breach for a data compromise to be realized by an unauthorized user. In this regard, according to surveys and research, thousands of laptops and other mobile devices are left in taxi cabs every month in major US cities, and many more are stolen every month. Regularly, news of high-profile data loss or exposure is reported, e.g., exposure of important company financial information or confidential plans, because of lost or stolen laptops/mobile devices.

Some conventional technologies have been proposed, but they each have significant gaps and/or limitations that prevent widespread adoption. For an overview of some problems with conventional attempts to protect data on devices, such as laptops, notebook computers, etc., such attempts have been vulnerable to attacks against laptops lost or stolen while in “sleep” mode, and also vulnerable to attacks where the locking does not technically enact until the device is powered-on.

Other attempts unfortunately suffer from vulnerability to dictionary or brute force attacks to gain access to a given file, user account, device, file system, etc. and some attempts are vulnerable to attacks whether the computer is powered on (even if it is locked), hibernated, or put to sleep.

Some programs also help to protect sensitive files and data on devices based on public/private keys, but many have usability problems and cannot be applied to all applications since, in order to be secure, the application is required to store all sensitive data, including temporary files, on an encrypted drive and any files or data stored outside of the application remain unprotected. While some applications and scenarios are conducive to operation under this constraint, many applications cannot operate effectively under this restraint without creating severe usability issues.

In this regard, a recurring problem of most protection technologies for laptops, notebooks, etc. is the tradeoff between secure configurations that have usability problems and usable configurations that have significant or unacceptable security weaknesses. For instance, a common protection measure for Smart Phones or similar devices is a built-in personal identification number (PIN), but the degree of protection provided by PIN is inherently limited. For example, a major shortcoming of PIN protection is that unencrypted information is stored on the device.

It is also possible to use a Web browser on a Smart Phone to access important information, e.g., via online web access (OWA), however a drawback is poor usability and dependency on a high speed data connection, e.g., on a slow connection, even without considering attachments, online email is practically unusable.

While a variety of digital rights management (DRM) solutions employing rights management servers (RMS) have also been proposed for certain digital data, such as emails, documents, songs, videos, etc., such protection is provided only for items that are actually sent or generated as DRM-protected

The above-described deficiencies of conventional data protection techniques for portable devices are merely intended to provide an overview of some conventional systems and some of the problems of such conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Data protection services for portable, handheld, or mobile device are provided in part by one or more cooperating network or data service(s), such as a cloud service, that provide volatile encryption/decryption key information to the device(s). Decryption key(s) are retrieved on demand by a device or application of the device from a network service or other data service based on an analysis of device credential(s). Retrieval of keys can be triggered automatically by meeting a set of pre-conditions by the device or application, or explicitly or implicitly requested by input to the device or application.

Since even strong keys can be represented compactly, any retrieved keys can be discarded or deleted from the device at any time at minimal cost of possible needing to retrieve another set of keys to decrypt the data again. Information for use by the mobile device can be retrieved from network storage and/or stored locally as encrypted data. Thus, decryption keys are provided to the mobile device in real time, on-demand, explicitly or implicitly defining a volatile lifetime prior to expiration of the decryption keys.

These and various other embodiments are described in more detail below.

### BRIEF DESCRIPTION OF THE DRAWINGS

Various non-limiting embodiments are further described with reference to the accompanying drawings in which:

FIG. 1 is an exemplary non-limiting block diagram of network based security or ecosystem in accordance with an embodiment;

FIG. 2 is a flow diagram illustrating an exemplary non-limiting process for requesting keys according to a cloud escrow agent service;

FIG. 3 is a block diagram illustrating the flexibility of local purge policy for deleting keys in accordance with an embodiment;

FIG. 4 is a flow diagram illustrating an exemplary non-limiting process for verifying identity information in connection with a device request for encryption keys according to an embodiment;

FIG. 5 is a flow diagram illustrating an exemplary non-limiting process for remote unlocking of a device according to an embodiment;

FIG. 6 is another exemplary non-limiting system diagram illustrating an embodiment for locking keys by a remote escrow agent in accordance with an embodiment;

FIG. 7 illustrates a non-limiting architecture for the various embodiments described herein including a policy layer and encryption barrier separating a device from encrypted data used by the device;

FIG. 8 illustrates that the provision of decryption key(s) from an escrow agent to a device can include a variety of cryptographic technologies. For instance, a challenge/response exchange between the escrow agent and device.

FIG. 9 is a block diagram representing exemplary non-limiting networked environments in which various embodiments described herein can be implemented; and

FIG. 10 is a block diagram representing an exemplary non-limiting computing system or operating environment in which one or more aspects of various embodiments described herein can be implemented.

### DETAILED DESCRIPTION

### Overview

As discussed in the background, some conventional technologies have been proposed to protect data on a device, but they each have significant gaps in security and/or limitations that prevent widespread adoption. In part consideration of the deficiencies of conventional technologies, in various embodiments, all data on a device is kept encrypted all of the time, including the data created by a device itself (e.g., recent calls list, audio recordings, etc.), whereas the encryption keys for the data are managed at the Escrow Server, which can either be a hosted service (e.g., a cloud service) or an enterprise-level server.

In one embodiment, decryption key(s) are retrieved on demand by a device or application of the device from a network service or other data service based on an analysis of device credential(s) by the network service. Retrieval of keys can be triggered automatically by meeting a set of pre-conditions by the device or application, or explicitly or implicitly requested by a user. Since keys are retrieved relatively easily by a portable device, e.g. from a WiFi network, a 3G network, etc., for the same reason, the keys can be discarded or deleted from the device while minimizing inconvenience at the mere cost of retrieving another set of keys. All information or all sensitive information on the mobile device is retrieved or stored as encrypted data (even in RAM).

In this regard, to eliminate the trust barriers that surround conventional provision of data protection services, a trusted cloud computing and data services ecosystem or framework is provided that achieves the above-identified objectives as well as other advantages highlighted in the various embodiments described below. The term “cloud” services generally refers to the notion that a service is performed not locally from a user's device, but rather delivered from one or more remote devices accessible via one or more networks. Since the user's device does not need to understand the details of what happens at the one or more remote devices, the service appears to be delivered from a “cloud” from the perspective of the user's device. In this respect, any data service that operates in a separate region of control from a given application process can appear to the device to be from a cloud due to the degree of independence of operation.

Further details of these and other various exemplary, non-limiting embodiments and scenarios are provided below.

### Data Protection for Portable Devices

In one embodiment, encryption/decryption keys for requested data are provided to mobile devices in real time from a network or data service, on-demand, e.g., when the user tries to open a specific e-mail or document. Then, the keys can be removed from memory of the mobile device so that the risk of exposure of the requested data is limited, e.g., limited to use of the specific e-mail/document and deleting the keys when the e-mail/document is closed, device is turned off, put to sleep, suspended, timed out, upon a power button event, etc. or other pre-conditions.

In addition to the device perspective, a cloud escrow network service is provided in an embodiment that stores various keys associated with the information stored on the device, or knows how to generate the various keys according to the given encryption technique or techniques adopted, e.g., time-hopping key systems, symmetric systems, asymmetric systems, searchable encryption systems, etc. Having keys stored at the cloud escrow service enables the use of aggressive policies for purging keys from the device at the first sign of a problem, or at the first sign of a potential problem (for high configuration scenarios) or only when a more serious pre-condition is met (for low configuration scenarios). For example, one policy is to delete the key on the local device as soon as the key is not in use, e.g., when the applicable document or e-mail is closed. Depending on the needs of a given scenario, the key retrieval can be on a file or item level basis, or on a more widespread basis applying to all of a given application's or device's data.

In one embodiment, the cloud escrow service handles three main tasks. First, it provides keys to the mobile device in real time, on as-needed or requested basis, preventing unauthorized access to underlying data prior to the time of need or request. The cloud escrow service can also use one or more authentication methods to verify that the device is permitted to retrieve keys, e.g., check that the device is in a secure state, check a biometric or other credentials of a user of the device, determine an unauthorized location, velocity, or path of the device, or otherwise check the device is being operated by an authorized user. At the network side, the cloud escrow service can also function as a remote lock service, refusing to provide keys if information is received by the cloud escrow service that the device is reported lost/stolen or suspicious signs have been pre-reported to the cloud escrow service, necessitating additional verification steps.

In one embodiment, the form of the remote lock implemented by the remote lock service is such that it is reversible “over-the-air,” or over a network by the remote lock service or a remote unlocking service as a separate entity. As a result, the remote lock does not cause data loss, and the device can be instantly unlocked, even when remote/travelling, e.g., as soon as some additional verification steps appropriate for the level of security concern governing the device at a given moment confirm that the device and its user are OK.

Depending on the application or scenario, and how a given user of one or more embodiments described herein wishes to diminish the potential for collusion by distributing trust, the cloud escrow service can be either a “true” cloud, e.g., hosted as an online service by a service provider, such as a cryptographic technology provider, or an escrow service hosted by the customer. In another possible topology, a service provider-hosted cloud service acts as a relay and management system, while using actual key storage hosted by the customer. Selection of these options is controlled by the tradeoff between ease of deployment vs. key protection level.

A multitude of local authentication factors, such as biometric or other user credentials, as well as cell carrier information, can be used to restrict keys to the rightful owner only. For example, if a smart phone changes its phone number or subscriber identity module (SIM) card, or the user roams outside of the country, it can be denied decryption keys for the information and the administrator or owner/user will need to re-register/unlock the keys.

Thus, in various aspects, due to the ease of re-acquisition of keys upon verification of identity, key management policies can be implemented with aggressive purging of a local key store by discarding keys at the first opportunity or at first sign of trouble or when some other set of pre-conditions is met for a given application.

As mentioned, in one embodiment, an online cloud escrow server is provided that acts as watchdog to detect suspicious activity and remotely lock or unlock a particular computing device in an intelligent manner. Use of a system, such as BitLocker, can be combined with a cloud escrow service such that at least one encryption layer can only be decrypted with reference to keys retrieved from the cloud, which keys themselves can be encrypted when passed over the network.

In this regard, a variety of traditional data protection technologies, such as PGP, EFS, BitLocker, DRM, can be augmented with the cloud escrow service by distributing at least one piece of the puzzle needed to access local data to a cloud service that satisfies requests for key information in real-time only if the requests satisfy certain pre-conditions enforced by the cloud escrow service. As a result, the keys received from the cloud escrow service can be deleted according to an aggressive security policy. Optionally, keys need not even be locally stored (other than fleetingly for use), instead they can be used and then discarded.

In this regard, a variety of local factors can affect access privileges to encrypted data, such as biometric data for authentication, cell carrier information received by the device, location information, etc. such that encryption keys are not released until the local factors are analyzed.

The provision of volatile keys enables strong protection for sensitive data stored on mobile devices with flexible configuration options—since the security level can be tweaked to the needs of specific application or customer. Since keys are typically compact, the solution offers a good compromise between usability and data protection since the retrieval of keys does not interfere with information synchronization models and does not introduce significant delays when accessing the data.

As a result of general applicability of the volatile key escrow agent concepts that can be tailored to the nature of data and its potential use and exposure, the various embodiments described herein offer a high degree of compatibility with and can be used to supplement the protection of existing technologies. For instance, various embodiments described herein can be provided as a layer on top of the e-mail/calendar data/contacts/etc. synchronization models, as well as support popular fetch and push models, but only fetching or pushing after fetching decryption keys in real-time. Optionally, keys that are retrieved, as a matter of statistical likelihood, are never the same as part of the cryptographic technology selected to encrypt and decrypt sensitive data on portable devices.

In one or more embodiments targeted to compact or portable form factors, such as mobile devices, phones, MP3 players, portable storage devices, etc., all information on the mobile device is encrypted preventing a would be thief or hacker from accessing any information on the device without the keys to decrypt the information. Decryption keys are provided to the mobile device on the fly, in real time, or on-demand, e.g., when the user tries to open specific e-mail or document, and keys are removed from Mobile Device RAM when the e-mail/document is closed or device is turning off or suspended (e.g., using power button or timeout). Various keys associated with the information stored on the device are stored by a cloud escrow service. Having keys stored at the cloud escrow service allows the use of aggressive policies for purging keys from the device at the first sign of a problem, and (for high configuration scenarios) as soon as the key is not in use (e.g. the document/e-mail is closed).

For any of the embodiments described herein involving a device with independent processing power, a similar or alternative set of devices can be provided where the context involves a device with limited computational resources, such as a memory peripheral (e.g., a USB flash memory drive or thumb stick). In such case, the host computer hosting the memory peripheral can provide the related computational resources and network access capabilities to retrieve keys and decrypt data stored on the device. In this respect, in such alternative embodiments, all of the data on the portable memory device can remain encrypted in the same way that all of the data on a portable computing device remains encrypted from external attack, if lost or stolen.

In one embodiment, the cloud escrow service provides the keys to the mobile device in real time, on as-need basis and uses a multitude of authentication methods to verify that the device is in secure state, location, etc. and is operated by an authorized user. In addition, the cloud escrow agent also functions as a remote lock service, refusing to provide keys if the device is reported lost/stolen, there are suspicious signs or the user cannot be authenticated and additional verification steps must be taken as a result.

The remote lock can be reversible over a network and does not cause data loss, so that the device can be instantly unlocked (even when remote/travelling) at minimal interference to use except some auxiliary verification step(s) to confirm that the device and its user are not blacklisted/do not represent unacceptable risk.

The cloud escrow service can be either be “true” cloud, such as a service hosted as an online service by a service provider, or an escrow service hosted by the customer.

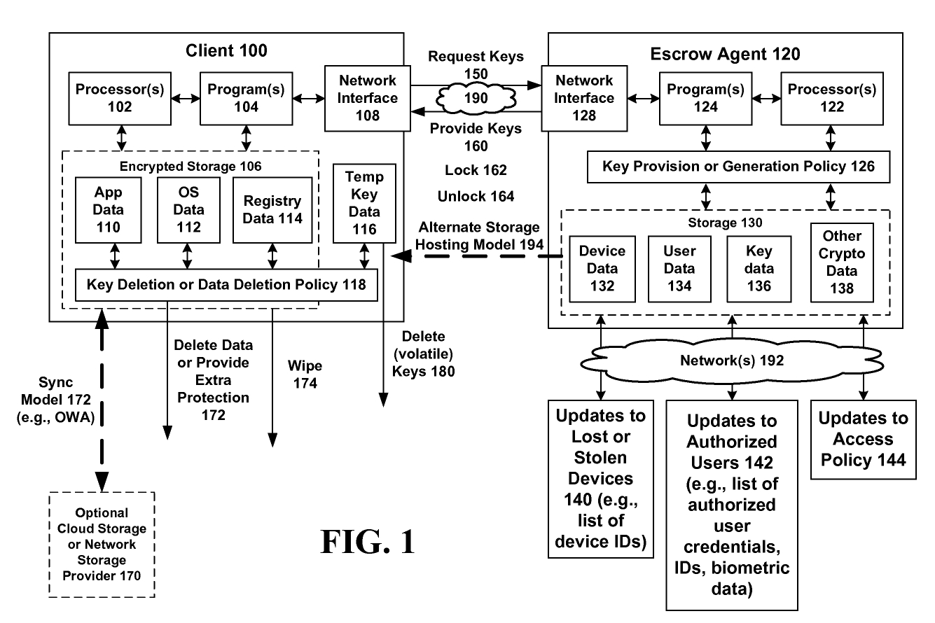

In FIG. 1, a client 100 includes processor(s) 102 for executing various program instructions 104, which may request access to encrypted storage 106. Encrypted storage 106 of client 100 may include a variety of data, such as application data 110 (e.g., documents, music files, etc.), operating system data 112, registry data 114, temporary key data 116, or other kinds of data. In accordance with various embodiments, on the client 100 side, a key deletion and/or data deletion policy 118 operates to delete data or provide extra protection to data 172, wipe data 174 and/or delete key(s) 180 whenever one or more sets of pre-conditions are met by the device 100 or use or non-use of a given set of data in encrypted storage 106. Temp key data 116 includes the key information needed to decrypt any of encrypted storage 106, and temp key data 116 may itself have a layer of encryption applied to it to further obscure the key data 116 even though it will not remain long on the device 100.

In addition to hosting storage 106 locally, any embodiment described herein works the same or similarly when interacting with encrypted storage provided by a third party storage provider 170, e.g., to support a synchronization interaction model 172, like OWA. In this regard, it is optional to interact with encrypted storage either locally or remotely, or a combination thereof. Further, it is optional to encrypt storage 106 on a comprehensive basis (all of the data), on a subset basis (e.g., all application data, but not other data), or on an item by item basis (e.g., each item or file in encrypted storage is encrypted with a different key), or according to a combination of the foregoing with multiple keys.

In various embodiments, when a program 104 or the like of device 100 requests access to one or more portions of encrypted storage 106, the program 104 makes a request for the keys to decrypt such portions in real time via network interface 108 of the device 100 and network interface 128 of escrow agent 120 via any one or more of network(s) 190. In turn, processor(s) 122 of escrow agent 120 execute escrow programs 124, which facilitate the decision of whether the client 100 will receive keys 160, get locked 162, get unlocked 164, etc. based on consultation of key provision or generation policy 126. Whether or not keys are provided can depend on storage 130, such as device ID data 132 or user ID data 134, updated by updates 140 and 142, respectively. Updates 144 to access policy are also received to maintain currency of data via any one or more of network(s) 192, which can be the same or different networks as network(s) 190.

Escrow agent 120 can either store pre-fabricated key data 136, or due to the ease with which keys can be generated, escrow agent can consult other cryptographic data 138 to generate keys, or a combination of the two options. Moreover, any of the storage items of storage 130 can be alternately hosted on the client according to an alternate hosting model 194 in which escrow agent 120 operates the same or similarly to other embodiments described herein, except that the escrow agent 120 acts more as a key manager or access administrator since storage takes place in a separate region of control on the device 100.

Thus, while a variety of embodiments herein presume escrow storage of key information, the escrow service can alternatively act as a relay and management system, while using actual key storage hosted by the customer. Selection of these options is controlled by the tradeoff between ease of deployment vs. key protection level.

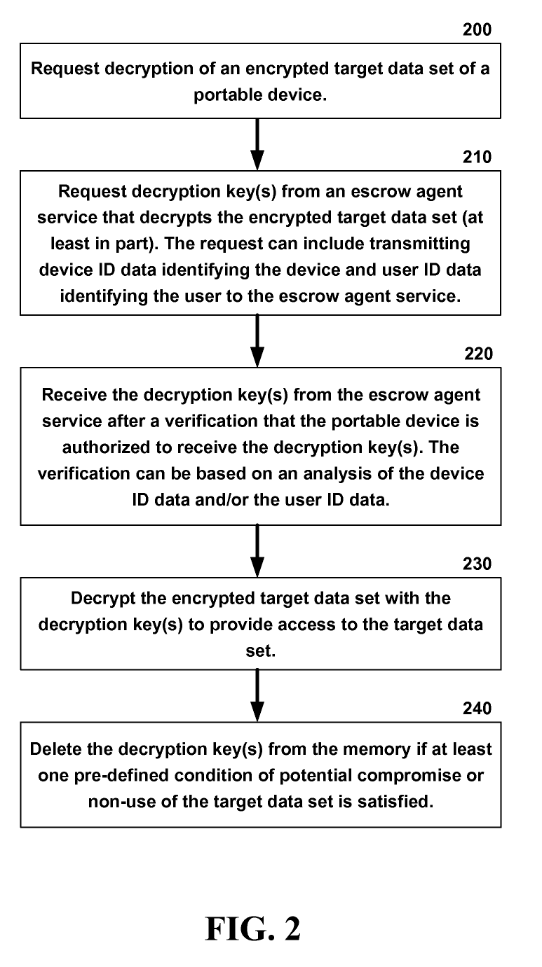

FIG. 2 is a flow diagram illustrating a non-limiting process for requesting encrypted data by a device in accordance with an embodiment. At 200, an application or other process (e.g., a boot up process) requests decryption of an encrypted target data set of a portable device. At 210, decryption key(s) are requested from an escrow agent service that decrypts the encrypted target data set. The request can include transmitting device ID data identifying the device and user ID data identifying the user to the escrow agent service, which is used in verifying the portable device is entitled to receive the requested key(s).

At 220, after a verification that the portable device is authorized to receive the decryption key(s), the decryption key(s) are received from the escrow agent service. The verification can be based on an analysis of the device ID data and/or the user ID data relative to a set of updated policies concerning the same. At 230, the encrypted target data set is decrypted with the decryption key(s) to provide access to the target data set. Next, at 240, the decryption key(s) are either deleted immediately after use or deleted from the memory when at least one pre-defined condition of potential compromise or non-use of the target data set is satisfied.

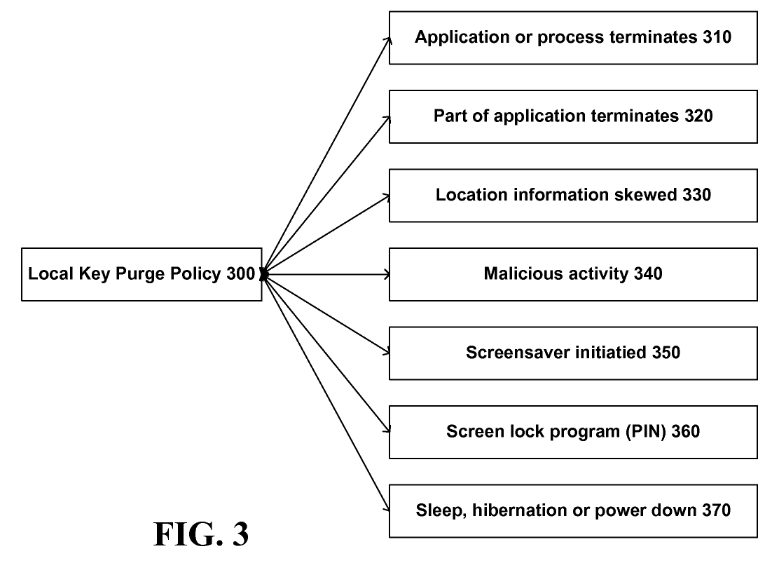

FIG. 3 illustrates some of the example, non-limiting conditions under which the client device might want to implement policy 300 to trigger deletion of keys on the device. For instance, keys might be deleted if a condition 310 is met that an application or process accessing the target data set is terminated. Keys might also be deleted if a condition 320 is met that an application or process terminates a portion of its operation accessing the target data set. As another example, keys might be deleted if a condition 330 is met that location information of the device identifying a geographical position of the device is out of a pre-defined geographical area.

Further, keys might be deleted if a condition 340 is met that a malicious process (e.g., malware, virus, hacking, etc.) is detected on the device. As yet another example, keys might be deleted if a condition 350 is met that a screensaver program for a display of a device is initiated. Similarly, keys might be deleted if a condition 360 is met that a screen lock program for a display of a device is initiated requiring a password or personal identification number (PIN) to unlock. Still further, keys might be deleted if a condition 370 is met that a sleep mode, hibernation mode or power off mode of the device is initiated.

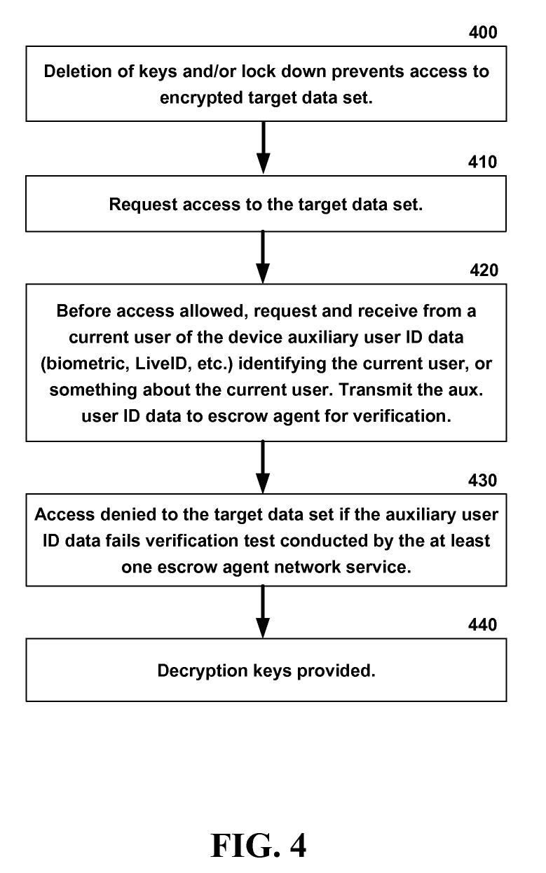

FIG. 4 is a flow diagram illustrating a non-limiting process for unlocking and retrieving keys after a potential security compromise in accordance with an embodiment. At 400, the device is in a state of being set by the escrow agent such that keys for certain data were purged, e.g., deleted and/or the data itself was locked down in a reversible manner. At 410, an application or other process makes a request to access a target data set. At 420, before access allowed, the escrow agent or the device requests and receives, from a current user of the device, auxiliary user ID data (biometric, LiveID, etc.) identifying the current user, or something about the current user. The auxiliary user ID data is transmitted to the escrow agent for auxiliary or enhanced verification.

At 430, access to the target data set is denied if the auxiliary user ID data fails verification test conducted by the escrow agent network service, e.g., a lock down of the device is initiated. If instead the enhanced verification test is passed at 440, confirming that the device is not lost or stolen, and safely in use by a proper user, decryption keys are provided or the device is unlocked according to the reversible locking procedure.

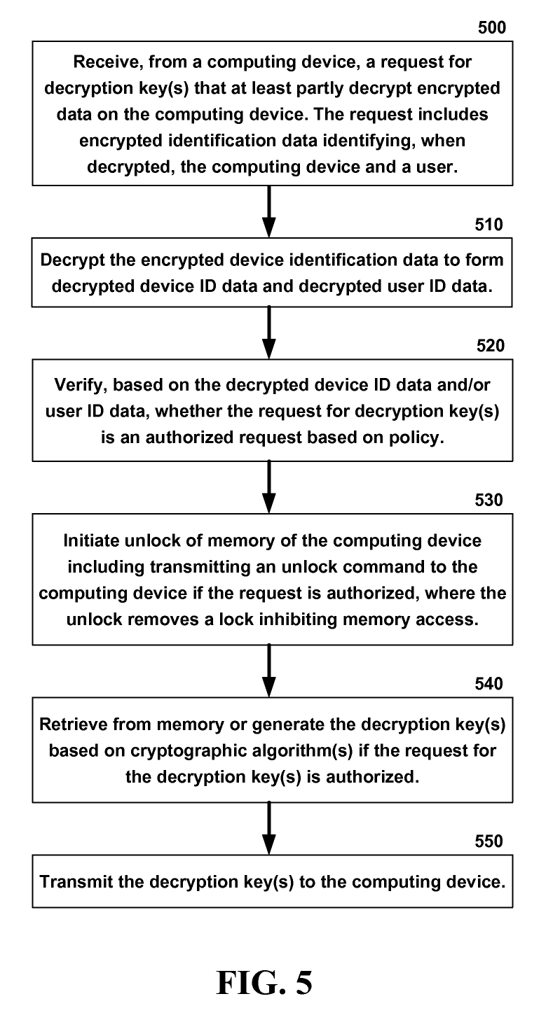

FIG. 5 is a flow diagram illustrating a non-limiting process for unlocking in accordance with an embodiment. At 500, a computing device requests decryption key(s) that at least partly decrypt encrypted data on the computing device. The request includes encrypted identification data identifying (when decrypted) the computing device and a user. At 510, the encrypted device identification data is decrypted. At 520, based on the decrypted device ID data and/or user ID data, it is determined whether the request for decryption key(s) is an authorized request based on policy.

At 530, if the request is authorized, where the unlock removes a lock inhibiting memory access, unlock of memory of the computing device is initiated by transmitting an unlock command to the computing device. If on the other hand the request for the decryption key(s) is authorized, at 540, the decryption key(s) are retrieved from memory or generated based on cryptographic algorithm(s). At 550, the decryption key(s) are transmitted to the computing device for a transitory existence relating to use of underlying data on the computing device.

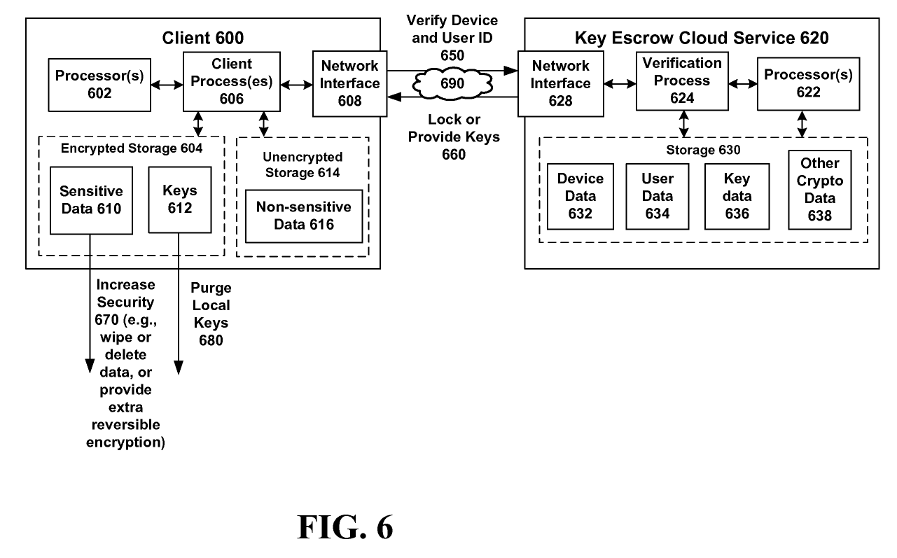

FIG. 6 is another exemplary non-limiting system diagram illustrating an embodiment. Before client 600 can use its resources, such as processor(s) and client process(es) 606, to access encrypted storage 604, the client requests decryption keys from a key escrow cloud service via respective interfaces 608, 628 via one or more networks 690. This involves verify process 650 of the device and user ID information. A verification process 624 executed by processor(s) 622 of key escrow cloud service 620 then consults storage 630 to learn what service 620 knows about devices 632 and knows about user 634 relative to the particular device and user ID information to determine if real-time permission should be granted. If so, the key data 636 is retrieved or other crypto data 638 is used to generate key data 636, or a combination.

As a result, the cloud service 620 either locks the encrypted storage 604 of client 600, which can include sensitive data 610 and/or keys 612, resulting in a reversible increase in security 670 for sensitive data 610 and/or a purge of local keys 680 to protect sensitive data 610 from decryption. Unencrypted storage 614 is also illustrated with non-sensitive data 616 to illustrate that the techniques of one or more embodiments described herein can be provided in parallel with ordinary storage techniques for non-sensitive data.

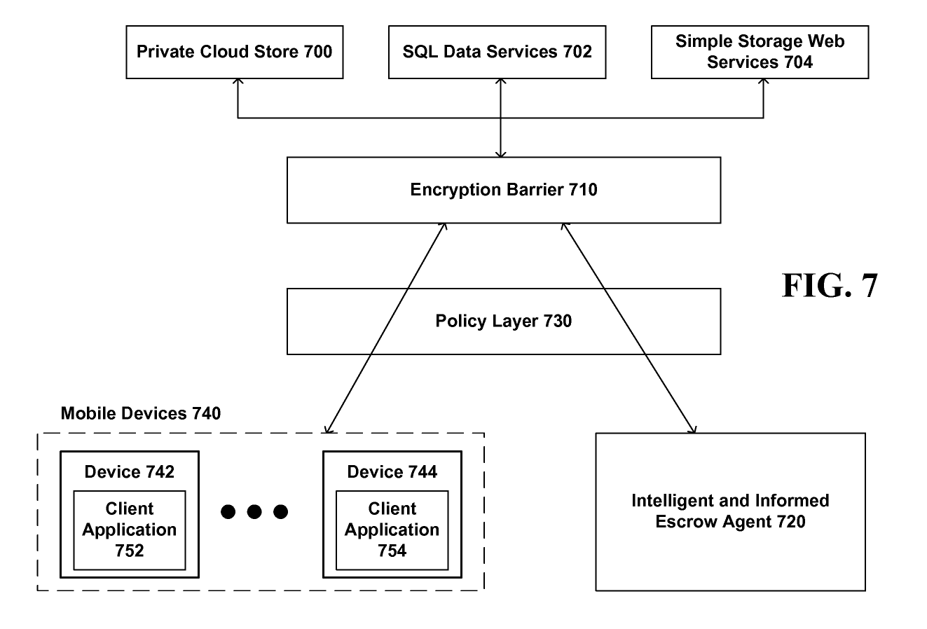

FIG. 7 illustrates a non-limiting architecture for the various embodiments described herein in which a set of mobile devices 740, such as device 742, device 744, etc. protect data generated by client applications 752, 754, respectively, by retrieving decryption keys from an external agent 720 if a policy layer 730 based on an analysis of a given device and its user is satisfied. If the policy layer 730 is satisfied, then the encryption barrier can be penetrated, which grants access to encrypted data requested by the mobile device wherever it may be stored. For instance, devices 740 may wish to interact with an encrypted private cloud store 700, encrypted SQL data services 702, simple storage web services 704, etc., or as mentioned, the data can be hosted local to the devices 740.

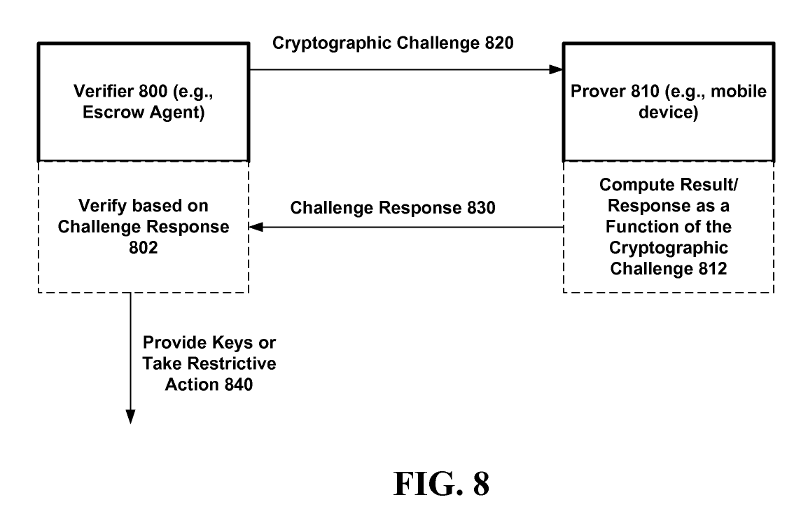

FIG. 8 illustrates that the provision of decryption key(s) from an escrow agent to a device can include a variety of cryptographic technologies. For instance, a challenge/response exchange between the escrow agent and device might include a verifier 800 (e.g., the escrow agent) issuing a cryptographic challenge 820 to a prover 810 (e.g., a mobile device). The prover 810 computers a result/response based at least partially on the cryptographic challenge 812 and transmits the challenge response 830 to the verifier 800 to verify the challenge 820 based on the challenge response 802. If the challenge/response is satisfied, then keys can be provided 840 (or if the challenge response fails, restrictive action can be taken).

### Exemplary Non-Limiting Implementations for Laptops

An exemplary implementation of one or more of the above-described ideas is in the context of laptops, notebooks, or other devices that have historically evolved from the perspective of duplicating a desktop experience in a portable form factor. With laptops, in one embodiment, a technology such as BitLocker, where all the data of the device is protected by an encryption layer, can make use of the cloud escrow service. For instance, with a BitLocker type implementation, a trusted platform module (TPM) detects that the user entered a PIN incorrectly more than the maximum number of retries and discards a locally stored key since the wrong PIN entry could be a sign of tampering.

Since the local key is discarded, the BitLocker hard drive becomes completely unusable and no repeated attacks on the TPM are possible since the key is physically erased from the local storage. If, however, this was just an operator mistake, user forgot the PIN, the user is nonetheless able to restore the BitLocker key from the cloud escrow service after going through the necessary steps of verifying identity. This could involve a multitude of methods, including SecureID, phone call/short message service (SMS) verification, etc. even if the user is roaming/outside of a given home network. As a result, the key is successfully recovered and normal BitLocker operation can resume.

If the device is reported as lost/stolen, or the user fails verification steps, the cloud escrow will in turn deny the key, preventing local attacks or attempts of decryption. This protection is strong since the key is physically erased from the laptop.

In the case of EFS or a similar system, similar to the BitLocker case, the EFS keys can be purged and recovered from the cloud escrow in real-time on an as-needed basis.

### Exemplary Non-Limiting Implementations for Mobile Devices

While the general models described herein can be applied to any type of computing device, the general model for mobile devices is similar to the Laptop case. For instance, SmartPhone PINs are frequently employed to unlock a display and such a system can be made to operate in a similar manner to the BitLocker embodiment, protecting base system information on the device (e.g., things like owner name, phone number, contacts, various information settings). The separation of the mobile device PIN and decryption of the information enables dual protection of the device data and the device is still safe in the event of PIN compromise. Both can be used simultaneously, or only the application information can be protected. In another embodiment, a mobile device PIN allows access to the phone functionality of the device and may allow access to some low-value information (like music files), but all high-value information (like contacts, credit card information, etc.) is strongly protected.

In addition to the SmartPhone-stored information, SIM card information can be protected via the same mechanism, since the location of the data is not critical, it is how protected the data is relative to volatile keys. In this regard, the SIM information too can be auto-erased at the first sign of trouble and be reversibly recovered from the Cloud Escrow after re-verification of access privileges.

As another example of a protection technology that can be enhanced with a volatile key and verification of identity system is RM technology. For instance, actual application and user data on the mobile device (such as e-mails, documents, recent call lists, address book, etc) can be protected by a variation of RM technology by encrypting all the information right away and relying on volatile keys stored by the cloud escrow service for decryption.

If the device is lost or stolen, the cloud escrow service can be notified, so any further requests for key decryption from this mobile device will be rejected. This makes information stored on the Mobile Device effectively useless to an attacker. Also, this solution protects against attempts to read information from the removable memory cards—files can be accessed, but they will be encrypted and the attacker will not have access to the key.

Yet another aspect of one or more embodiments described herein is that information generated on the mobile phone. For example, it can be used to protect a Recent Calls list. When the Recent Calls list is created or updated, the mobile device encrypts it with a symmetric key (e.g., a nonce), and encrypts this key with a public key of the cloud escrow service. After that, the Recent Calls list becomes protected and cannot be read until the Cloud Escrow Service helps to recover the key used to protect it.

### Exemplary Networked and Distributed Environments

One of ordinary skill in the art can appreciate that the various embodiments of methods and devices for network based security and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

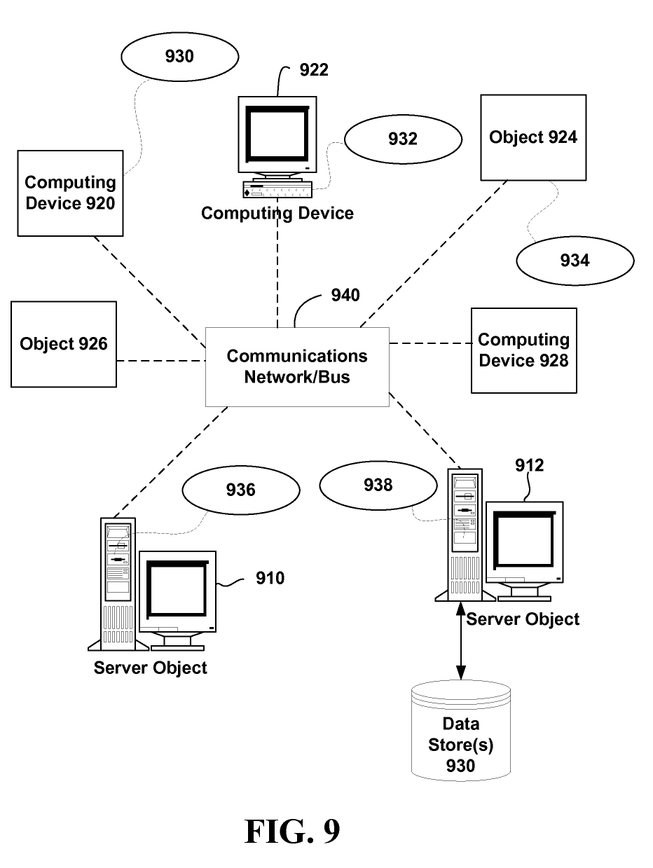

FIG. 9 provides a non-limiting schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that objects 910, 912, etc. and computing objects or devices 920, 922, 924, 926, 928, etc. may comprise different devices, such as PDAs, audio/video devices, mobile phones, MP3 players, laptops, etc.

Each object 910, 912, etc. and computing objects or devices 920, 922, 924, 926, 928, etc. can communicate with one or more other objects 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each object 910, 912, etc. or 920, 922, 924, 926, 928, etc. can also contain an application, such as applications 930, 932, 934, 936, 938, that might make use of an API, or other object, software, firmware and/or hardware, suitable for communication with or implementation of a service or mobile device as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 9, as a non-limiting example, computers 920, 922, 924, 926, 928, etc. can be thought of as clients and computers 910, 912, etc. can be thought of as servers where servers 910, 912, etc. provide data services, such as receiving data from client computers 920, 922, 924, 926, 928, etc., storing of data, processing of data, transmitting data to client computers 920, 922, 924, 926, 928, etc., although any computer can be considered a client, a server, or both, depending on the circumstances. Any of these computing devices may be processing data, or requesting services or tasks that may implicate the improved data protection and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the key services can be provided standalone, or distributed across multiple computing devices or objects.

In a network environment in which the communications network/bus 940 is the Internet, for example, the servers 910, 912, etc. can be Web servers with which the clients 920, 922, 924, 926, 928, etc. communicate via any of a number of known protocols, such as the hypertext transfer protocol (HTTP). Servers 910, 912, etc. may also serve as clients 920, 922, 924, 926, 928, etc., as may be characteristic of a distributed computing environment.

### Exemplary Computing Device

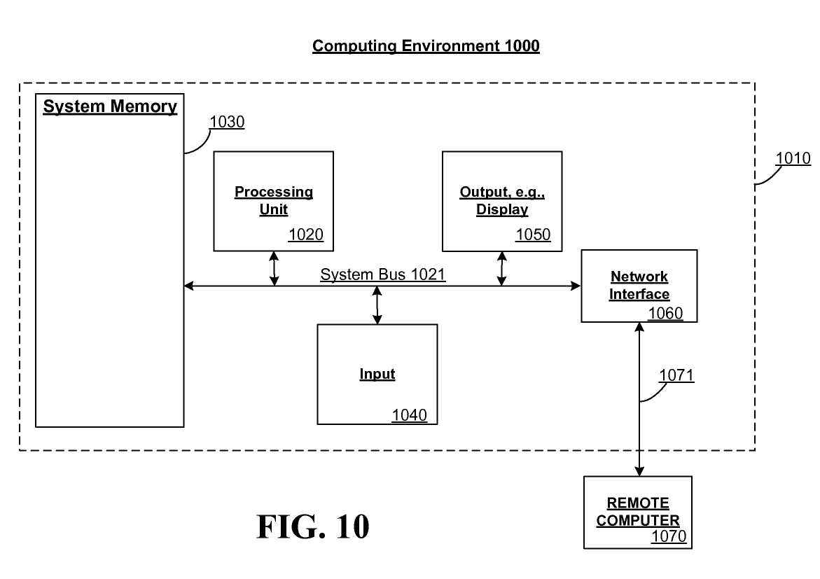

As mentioned, various embodiments described herein apply to any device wherein it may be desirable to implement one or pieces of network based security. It should be understood, therefore, that handheld, portable and other computing devices and computing objects of all kinds are contemplated for use in connection with the various embodiments described herein, i.e., anywhere that a device may provide some functionality in connection with network based security. Accordingly, the below general purpose remote computer described below in FIG. 10 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 10 thus illustrates an example of a suitable computing system environment 1000 in which one or more of the embodiments may be implemented, although as made clear above, the computing system environment 1000 is only one example of a suitable computing environment and is not intended to suggest any limitation as to the scope of use or functionality of any of the embodiments. Neither should the computing environment 1000 be interpreted as having any dependency or requirement relating to any one or combination of components illustrated in the exemplary operating environment 1000.

With reference to FIG. 10, an exemplary remote device for implementing one or more embodiments herein can include a general purpose computing device in the form of a handheld computer 1010. Components of handheld computer 1010 may include, but are not limited to, a processing unit 1020, a system memory 1030, and a system bus 1021 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, memory 1030 may also include an operating system, application programs, other program modules, and program data.

A user may enter commands and information into the computer 1010 through input devices 1040 A monitor or other type of display device is also connected to the system bus 1021 via an interface, such as output interface 1050. In addition to a monitor, computers may also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1071, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and architectures, the underlying concepts may be applied to any network system and any computing device or system in which it is desirable to bolster security of storage access in connection with interactions with a cloud service.

There are multiple ways of implementing one or more of the embodiments described herein, e.g., an appropriate API, tool kit, driver code, operating system, control, standalone or downloadable software object, etc., which enable devices, applications, and services to benefit from network based security applied to protect data or subsets of data in one or more embodiments herein. Embodiments may be contemplated from the standpoint of an API (or other software object), as well as from a software or hardware object that provides security services in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on processor, processor, an object, an executable, a thread of execution, a program, a computer or a combination of any one or more of the foregoing non-exhaustive list. By way of an illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage, e.g., a memory, and at least one processor configured to practice the method.

While the various embodiments have been described in connection with the preferred embodiments of the various figures, it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for extracting data from at least one encrypted data store storing at least one encrypted data set, comprising:
requesting decryption of an encrypted target data set of the at least one encrypted data set by a portable device;
requesting at least one decryption key from at least one escrow agent data service that at least partly decrypts the encrypted target data set from the at least one encrypted data set including transmitting identity data to the at least one escrow agent data service;
decrypting the encrypted target data set with the at least one decryption key received from the at least one escrow agent data service to provide access to the target data set by the portable device; and
deleting the at least one decryption key from the memory if at least one pre-defined condition of potential compromise or non-use of the target data set is satisfied.

2. The method of claim 1, wherein the deleting includes deleting the at least one decryption key from the memory substantially immediately after use of the at least one decryption key.

3. The method of claim 1, further comprising:
after the deleting, requesting and receiving auxiliary user identity data identifying a current user of the device;
requesting access to at least a subset of the target data set; and
denying access to at least the subset if the auxiliary user identity data fails a verification test conducted by the at least one escrow agent network service.

4. The method of claim 3, wherein the requesting and receiving of auxiliary user identity data includes receiving biometric user identity data.

5. The method of claim 1, wherein the deleting includes deleting the at least one decryption key from the memory if an application or process accessing the target data set is terminated.

6. The method of claim 1, wherein the deleting includes deleting the at least one decryption key from the memory if an application or process terminates a portion of its operation accessing the target data set.

7. The method of claim 1, wherein the deleting includes deleting the at least one decryption key from the memory if location information of the device identifying a geographical position of the device is out of a pre-defined geographical area.

8. The method of claim 1, wherein the deleting includes deleting the at least one decryption key from the memory if at least one potentially malicious process is detected on the device.

9. The method of claim 1, wherein the deleting includes deleting the at least one decryption key from the memory if a screensaver program for a display of a device is initiated.

10. The method of claim 1, wherein the deleting includes deleting the at least one decryption key from the memory if a screen lock program for a display of a device is initiated requiring a password or personal identification number (PIN) to unlock.

11. The method of claim 1, wherein the deleting includes deleting the at least one decryption key from the memory if a sleep mode, hibernation mode or power off mode of the device is initiated.

12. The method of claim 1, further comprising:
receiving the at least one decryption key from the at least one escrow agent data service in memory of the portable device after a verification process verifies the portable device is authorized to receive the at least one decryption key at least based on an analysis of the device identity data and the user identity data.

13. The method of claim 1, wherein the requesting of at least one decryption key includes transmitting at least one of device identity data identifying the device or user identity data identifying the user to the at least one escrow agent.

14. A server computer for providing key escrow agent services for the provision of volatile key information to individual computing devices, comprising:
at least one memory for storing data and computer executable instructions; and
at least one processor for executing computer executable instructions stored in the memory to perform the following acts:
receiving, from a computing device, a request for at least one decryption key that at least partly decrypts data on the computing device including receiving encrypted device identification data identifying the computing device when decrypted and encrypted user identification data identifying a user of the computing device when decrypted;
decrypting the encrypted device identification data to form decrypted device identification data and decrypted user identification data; and
verifying, based on at least one of the decrypted device identification data or the decrypted user identification data, whether the request for the at least one decryption key is an authorized request.

15. The server computer of claim 14, wherein the at least one processor carries out computer executable instructions to perform the receiving of the request for at least one decryption key that decrypts all of the data on the computing device.

16. The server computer of claim 14, wherein the at least one processor further carries out computer executable instructions stored in the memory to perform the act of:
initiating an unlock of memory of the computing device including transmitting at least one unlock command to the computing device if the request for the at least one decryption key is an authorized request, where the unlock removes a lock inhibiting memory access on the computing device.

17. The server computer of claim 14, wherein the at least one processor further carries out computer executable instructions stored in the memory to perform the acts of:
retrieving the at least one decryption key from the at least one memory if the request for the at least one decryption key is an authorized request; and
transmitting the at least one decryption key to the computing device.

18. The server computer of claim 14, wherein the at least one processor further carries out computer executable instructions stored in the memory to perform the acts of:
generating the at least one decryption key based on at least one cryptographic algorithm if the request for the at least one decryption key is an authorized request; and
transmitting the at least one decryption key to the computing device.

19. The server computer of claim 14, wherein the at least one processor carries out computer executable instructions to perform the verifying including determining whether the computing device is reported lost or stolen based on data matching the decrypted device identification data.

20. The server computer of claim 14, wherein the at least one processor carries out computer executable instructions to perform the verifying including determining whether the computing device is currently being operated by an unauthorized user based on data matching the decrypted user identification data.

21. A handheld computing system, comprising:
at least one encrypted data store storing encrypted data for which decryption cryptographic key information is a pre-requisite for access;
at least one processor configured to carry out computer executable instructions that transmit a request for the decryption cryptographic key information from an escrow agent network service at a time in response to a request for access of target data of the at least one encrypted data store, receive the decryption cryptographic key information if the escrow agent network service verifies at least one of a device condition associated with an identity of the handheld computing device or a user condition associated with an identity of a user of the handheld computing device and lock the at least one encrypted data store if the escrow agent network service does not verify the device condition or user condition.
